(19) United States
(12) Patent Application Publication
(10) Pub. No.: US 2004/0240716 A1
(43) Pub. Date: Dec. 2, 2004

(54) Analysis and display of fluorescence images

(76) Inventors: Elbert de Josselin de Jong, Bussum (NL); Monique van der Veen, Almere (NL); Elbert Waller, Amsterdam (NL)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/851,817

(22) Filed: May 21, 2004

Related U.S. Application Data
(60) Provisional application No. 60/472,486, filed on May 22, 2003.
(60) Provisional application No. 60/540,630, filed on Jan. 31, 2004.

(51) Int. Cl. G06K 9/00; A61C 5/00

(52) U.S. Cl. 382/128; 433/215

(57) ABSTRACT

Systems and methods are described for visualizing, measuring, monitoring, and observing damage to and decalcification of tooth tissue in a lesion based on one or more still images of the tooth, each preferably observing through an optical filter the fluorescent response of the tissue to blue excitation light. The image is analyzed based on a function(s) of optical components of the pixels, preferably comparing a ratio between optical components to one or more thresholds. Other analysis uses interpolation and/or curve fitting to reconstruct what intensities the pixels would have if the tooth were sound. In some embodiments, this reconstruction is based on the pixel intensities that the user indicates correspond to sound tooth tissue. In other embodiments, these points are automatically selected. In still other embodiments, images captured over time are analyzed to create a sequence of frames in an animation of the state of the lesion.

### CROSS-REFERENCE TO RELATED APPLICATIONS

This application contains subject matter related to U.S. patent application Ser. No. 10/209,574, filed Jul. 31, 2002 (the “Inspection” application), a U.S. Patent Application titled “Fluorescence Filter for Tissue Examination and Imaging” filed of even date herewith (the “Fluorescence Filter” application), and U.S. Pat. No. 6,597,934 (the “Software Repositioning” patent), and claims priority to U.S. Provisional Application Nos. 60/472,486, filed May 22, 2003, and 60/540,630, filed Jan. 31, 2004. These applications and patent are hereby incorporated by reference in their entireties.

### FIELD OF THE INVENTION

The present invention relates to quantitative analysis of digital images of fluorescing tissue. More specifically, the present invention relates to methods, systems, and apparatus for analyzing digital images of dental tissue to quantify and/or visualize variations in the state of the dental tissue due to disease or other damage.

### BACKGROUND

Various techniques exist for evaluating the soundness of dental tissue, including many subjective techniques (characterizing an amount of plaque mechanically removed by explorer, floss, or pick, white-light visual examination, radiological examination, and the like). Recent developments include point examination techniques such as DIAGNODENT by Ka Vo America Corporation (of Lake Zurich, Ill.), which is said to measure fluorescence intensity in visually detected lesions.

With each of these techniques, longitudinal analysis is difficult at best. Furthermore, significant subjective components in many of these processes make it difficult to achieve repeatable and/or objective results, and they are not well adapted for producing visual representations of lesion progress.

It is, therefore, an object of the invention to provide an improved method for enhancing the available information about plaque, calculus, and carious dental tissue otherwise invisible to the human eye, and to objectify longitudinal monitoring by recording the information at each measurement and providing quantitative information based on the image(s). Another object is to improve visualization and analysis of the whole visible tooth area, not limiting them to just a particular point. Still another object is to enhance information available to patients to motivate them toward better hygiene and earlier treatment.

### SUMMARY

Accordingly, in one embodiment, the invention provides a method of image analysis, comprising capturing additional images of tooth tissue, and for each of a plurality of pixels in the image, determining a first component value of the pixels color and a second component value of the pixels color, and calculating a first function value for the pixel based on the component values. In some embodiments, the first component is a red color component of the pixel, the second component is a green color component of the pixel, and the function is a ratio of the red component value to the green component value. In other embodiments, the pixels original color may be replaced by an alternate color depending upon the value of the first function calculated as to that pixel. In some of these embodiments, the modified image is displayed or stored, and may be combined with other modified images to construct an animated sequence.

In some embodiments, the function is calculated over all pixels in the image, while in other embodiments the function is applied only to one or more specified regions.

Another embodiment is a method of quantifying calcium loss due to a white spot lesion on a tooth. An image of the fluorescence of the tooth due, for example, to incident blue light, is captured as a digital image. A plurality of points defining a closed contour around a plurality of pixels are selected, and a reconstructed intensity value is calculated for each pixel within the contour. The sum of the differences between the reconstructed intensity values and actual intensity values for each of the pixels within the contour is calculated and quantifies the loss of fluorescence. In some forms of this embodiment, the actual intensity value for each pixel is a function of a single optical component of the pixel, such as a red component intensity. In other forms, the reconstructed intensity value for each pixel is calculated using linear interpolation, such as interpolating between intensity values of one or more points on the contour. In some implementations of this form, the points on the contour lie on or adjacent to a line through the given pixel, where the line is perpendicular to a regression line that characterizes the region surrounded by the contour.

Another embodiment is a system that comprises a processor and a memory, where the memory is encoded with programming instructions executable by the processor to quantitatively evaluate the decalcification of a white spot based on a single image. In some embodiments of this form, the user selects points on the image around the white spot, where each point is assumed to be healthy tissue. “Reconstructed” intensities are calculated for each point within the closed loop, and a result quantity is calculated based on these values and the pixel values in the image.

### BRIEF DESCRIPTION OF THE DRAWINGS

FIG. 1 is a representative image of the side view of a tooth, the image of which is to be analyzed according to the present invention.

FIG. 2 is a flowchart depicting the method of analysis according to one embodiment of the present invention.

FIG. 3 is a hardware and software system for capturing and processing image data according to one embodiment of the present invention.

FIG. 4 is a representative image of a tooth with a white spot lesion for analysis according to a second form of the present invention.

FIG. 5 is a two-dimensional graph of selected features from FIG. 4.

FIG. 6 shows certain features from FIG. 4 in the context of calculating a reconstructed intensity value for a particular point in the image.

FIG. 7 is a graph of measured and reconstructed intensity along line l in FIG. 6.

FIG. 8 illustrates quantities used for analysis in a third form of the present invention.

FIG. 9 is a series of related images and graphs illustrating a fourth form of the present invention.

FIG. 10 is a graph and series of image cells illustrating a fifth form of the present invention.

FIG. 11 is a graph of quantitative remineralization data over time as measured according to the present invention.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

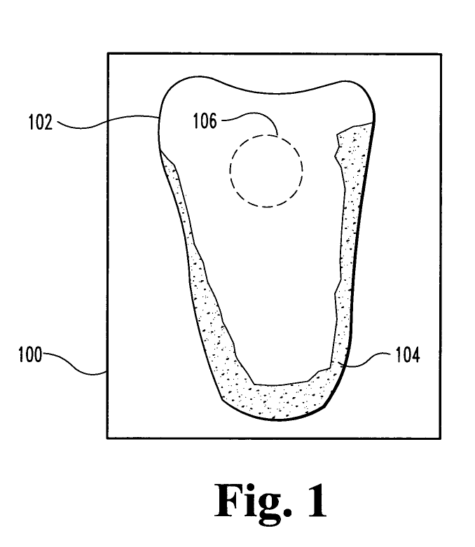

FIG. 1 represents a digital image of the side of a tooth for analysis according to the present invention. Of course, any portion of a tooth might be captured in a digital image for analysis using any camera suitable for intra-oral imaging. One exemplary image capture device is the combination light, camera, and shield described in the U.S. Patent Application titled “Fluorescence Filter for Tissue Examination and Imaging” (the “Fluorescence Filter” application), which is being filed of even date herewith. Alternative embodiments use other intra-oral cameras. The captured images are preferably limited to the fluorescent response of one or more teeth to light of a known wavelength (preferably between about 390 nm and 450 nm), where the response is preferably optically filtered to remove wavelengths below about 520 nm.

FIG. 1 represents image 100, including a portion of the image 102 that captures the fluorescence of a particular tooth. A carious region 104 extends along the gum and appears red in image 100. In this embodiment, a user has positioned a circle on the image to indicate a clean area 106 of the tooth that appears healthy. In alternative embodiments, the portions of image 100 corresponding to the tooth 102 and/or clean area 106 may be automatically determined by image analysis, as described below.

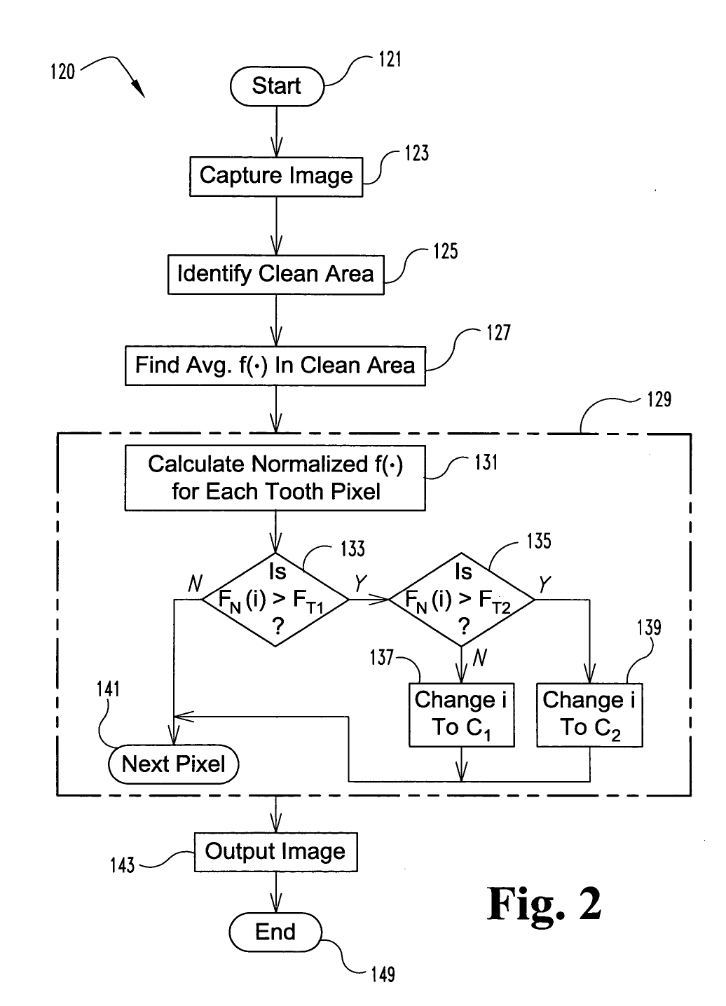

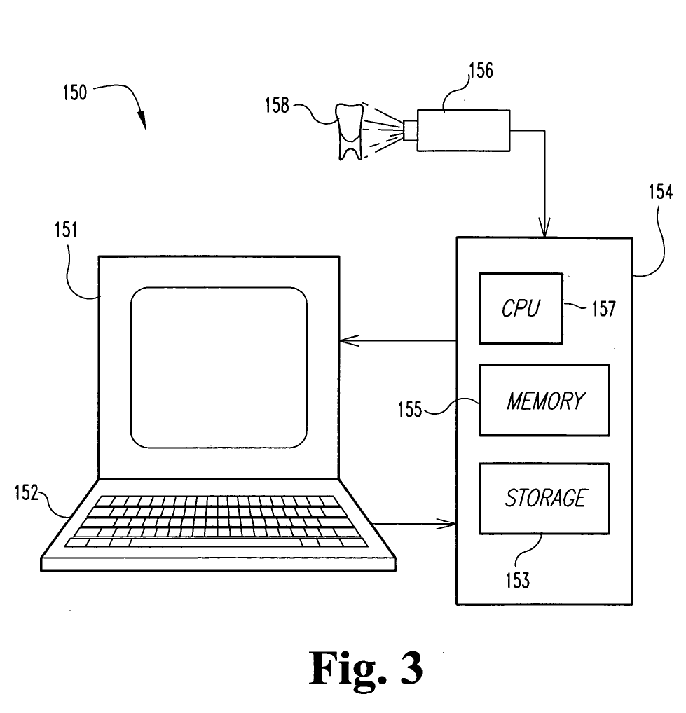

FIG. 2 describes in a flowchart the process 120, which is applied to image 100 in one embodiment of the present invention. Process 120 begins at start point 121, and the system captures the digital image at step 123. An example of a system for capturing an image at step 123 is illustrated in FIG. 3. System 150 includes a monitor 151 and keyboard 152, which communicate using any suitable means with computer unit 154, such as through a PS/2, USB, or Bluetooth interface. Unit 154 houses storage 153, memory 155, and a processor 157 that controls the capturing and processing functions in this embodiment. This includes, but is not limited to, controlling camera 156 to acquire digital images of tooth 158 or other dental tissue for analysis, preferably according to the techniques discussed in the Software Repositioning, Inspection, and Fluorescence Filter patent and applications.

Returning to FIG. 2, a clean area of the tooth is identified or selected at step 125 by manual or automatic means. For example, a user might accomplish this manually by positioning and sizing a circle on a displayed version of the image using a graphical user interface. In other embodiments, the system selects or proposes a clean area of the image by finding the pixel(s) having the highest (or lowest) value of a particular function over the domain of the tooth image. A circle centered at the point (or the centroid of points) corresponding to that maximum, a circle circumscribing each of those points, or other selection means may be used.

When the clean area has been selected or defined, at block 127 the system finds the average of a particular function ƒ(·) over the two-dimensional region that makes up the clean area 106. In this embodiment, function ƒ(·) is a ratio of red intensity R(i) to green intensity G(i) at each pixel i. Thus, ƒ(i)=R(i)/G(i), and the average is

$${F}_{c} = \frac{{\sum }_{i ∈ C}^{} f ( i )}{\{ \# of pixels in C \}} .$$

The color data for each pixel is then analyzed in a loop at pixel subprocess block 129. There, a normalized function F_{N}(i)=ƒ(i)/F_{C} is calculated for the pixel i. It is determined at decision block 133 whether that normalized value is greater than a predetermined threshold; that is, whether F_{N}(i)>F_{T1}. In this sample embodiment, this threshold F_{T1} is defined as 1.1, but other threshold values F_{T1} can be used based on automatic adjustment or user preference as would occur to one of ordinary skill in the art. If the threshold is not exceeded, the negative branch of decision block 133 leads to the end of pixel subprocess 129 at point 141.

If, instead, the normalized function value F_{N}(i) is greater than the threshold F_{T1} for the pixel being considered (a positive result at decision block 133), it is determined at decision block 135 whether the normalized value exceeds the second threshold; that is, whether F_{N}(i)>F_{T2}. If not (a negative result), the system changes the color of pixel i to a predetermined color C₁ at block 137, then proceeds to process the next pixel via point 141, which is the end of pixel subprocess 129. If the normalized function value F_{N}(i) exceeds the second threshold F_{T2} (a positive result at decision block 135), the system changes the color of pixel i to a predetermined color C₂ at block 139. The system then proceeds to the next pixel via point 141.

When each pixel in the tooth portion 102 of image 100 has been processed by pixel subprocess 129, the image is output from the system at block 143. In various embodiments, the image can be displayed on a monitor 151 (see FIG. 3), saved to a storage device 153, or added to an animation (as will be discussed below).

In a preferred form of this embodiment, predetermined colors C₁ and C₂ are selected to stand out from the original image data, such as choosing a light blue color for pixels with normalized R/G ratios higher than F_{T1}=1.1, and a medium blue color for pixels having normalized R/G ratios higher than F_{T2}=1.2. Of course, other thresholds and color choices will occur to those skilled in the art for use in practicing this invention. Furthermore, more or fewer ratio thresholds and corresponding colors may be used in other alternative forms of this embodiment of the invention. Still further, in still other embodiments pixels having a normalized function value F_{N}(i) less than the lower or lowest threshold F_{T1} are replaced with a neutral, contrasting color such as gray, black, beige, or white.

This process 120 is particularly useful for performing a longitudinal analysis of a patient's condition over time during treatment. For example, a series of images taken before, during, and after treatment often reveals strengths and weaknesses of the treatment in terms of efficacy in an easily observable, yet objective way. The use of R/G ratios instead of simple intensity measurements in these calculations reduces variations resulting from slightly different lighting conditions or camera configurations. One can further improve the data available for longitudinal analysis by combining the teachings herein with those of U.S. Pat. No. 6,597,934, cited above.

When multiple images have been captured of a particular subject, techniques known in the image processing art can be applied to generate an animation from those images. In one form of this embodiment, captured images are simply placed in sequence to yield a time-lapse animation. In other forms, the time scale is made more consistent by placing reconstructed images between captured images to provide a consistent time scale between frames of the animation. Some of these techniques are discussed herein.

Several metrics can be calculated using pixel-specific and image-wide data described above. For example, assume that C is a set of pixels in the clean area of the tooth, L is a set of pixels i for which F_{N}(i)<F_{T1}, and s is the amount of surface area of the tooth represented by a single pixel in the image (obtained as part of the image capture process or calculated using known methods). Then the lesion area A=s·{pixels in L}. A measurement of fluorescence loss in the lesion is calculated as

$$Δ F = \frac{\{ average G ( i ) over L \} - \{ average G ( i ) over C \}}{\{ average G ( i ) over C \}} .$$

This value of ΔF describes the lesion depth as a proportion or percentage of fluorescence intensity lost.

Another useful metric is the integrated fluorescence lost, ΔQ=A·ΔF, which describes the total amount of mineral lost from the lesion in area-percentage units (such as mm²·%). This metric was used to evaluate a white spot lesion over a one-year period following orthodontic debracketing. The collected data, shown in FIG. 11, reflects an expected remineralization of the lesion over the monitoring period.

Additional methods for evaluating lesions according to the present invention will now be discussed in relation to FIGS. 4-10. Generally, in using this evaluation technique, an image is considered by a user, who selects a series of points on the image that define a closed contour (curve C) around damaged tissue, a white spot lesion in this example. A computing system estimates the original intensity values using calculated “reconstructed” intensity values for points within the contour, and compares those reconstructed values with the actual measured values from the image. The comparison is used to assess the calcium loss in the white spot. Other techniques and applications are discussed herein.

Turning to FIG. 4, an image of a tooth with a white spot lesion is shown, whereon a user has identified points P₁-P₉. In this embodiment the user clicks a mouse button in a graphical user interface to select each point, then clicks the starting point again to close the loop. In other embodiments, other interfaces may be used, or automated techniques that are known to those skilled in the image processing arts may be used to define the contour. This description will refer to the region R of the image enclosed by the curve, or contour, C through points P₁-P₉.

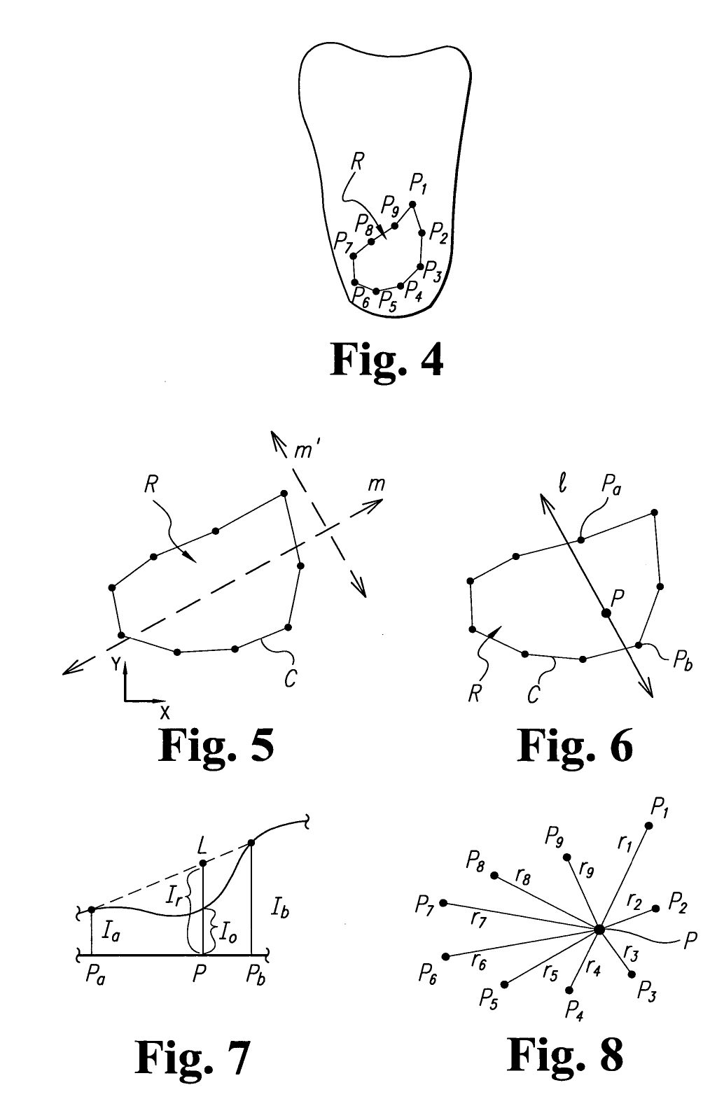

Region R is illustrated again in FIG. 5, with x- and y-axes, which may be arbitrarily selected, but provide a fixed frame of reference for the remainder of the analysis in this exemplary embodiment. A linear regression algorithm is applied to the region to determine a slope m that characterizes the primary orientation of the white spot in the image relative to the x-axis. The slope of a line perpendicular to the regression line will be used in the present method, and will be referred to as m′=−1/m.

Once the slope of interest m′ is determined, a reconstructed intensity value is determined for each pixel in region R. Since the portions of the tooth along the line segments connecting P₁-P₉ are presumed to be healthy tissue, those values are retained in the reconstructed image. For those points strictly within region R (that is, within but not on the closed curve C), the values are interpolated as follows. As illustrated in FIG. 6, a line l of slope m′ is projected through each such point P to two points (Pₐ and P_{b}) on curve C. A reconstructed intensity value Iᵣ is calculated for point P as the linear interpolation between intensities at points Pₐ and P_{b}, where line l intersects curve C.

Linear interpolation in this context is illustrated in FIG. 7. FIG. 7 is a graph of intensity values (on the vertical axis) versus position along line l (on the horizontal axis), wherein the intensity at point Pₐ in the image is Iₐ, the intensity at P_{b} in the image is I_{b}, and the intensity at point P in the image is Iₒ. The “reconstructed” intensity at point P is Iᵣ, calculated as the result of linear interpolation between Iₐ and I_{b} according to the formula

$${I}_{r} = {I}_{b} - ( {I}_{b} - {I}_{a} ) ( \frac{{X}_{b} - X}{{X}_{b} - {X}_{a}} ) ,$$

where X, Xₐ, and X_{b} are the x-coordinates of points P, Pₐ, and P_{b}, respectively. A useful value that characterizes the damage to the tissue is the fluorescence loss ratio,

$$Δ F = \frac{{I}_{r} - {I}_{o}}{{I}_{r}} .$$

Where decalcification has occurred, ΔF>0.

A useful metric L for fluorescence loss in a lesion is the sum of ΔF over all the pixels within curve C; that is,

$$L = {\sum }_{i ∈ R}^{} Δ F ( i ) .$$

Other metrics L′ and L″ take the sum of ΔF over only pixels for which reconstructed intensity Iᵣ is a certain (multiplicative) factor or (subtractive) differential less than the actual, measured intensity Iₒ; that is, given R′={i: Iₒ<(Iᵣ−ε)} and R″={i: Iₒ<βIᵣ} for some predetermined ε and β, then

$${L}^{′} = {\sum }_{i ∈ {R}^{′}}^{} Δ F ( i ) and {L}^{″} = {\sum }_{i ∈ {R}^{″}}^{} Δ F ( i ) .$$

Other interpolation and curve-fitting methods for reconstructing or estimating a healthy intensity Iᵣ will occur to those skilled in the art based on this discussion. For example, a two-dimensional smoothing function can be applied throughout region R, so that many values along curve C affect the reconstructed values for the points within the curve.

In some embodiments, one or more points along curve C can be ignored in the interpolation, and alternative points (such as, for example, a line through point P having a slope slightly increased or decreased from m′) could be used. This “ignore” function is useful, for example, in situations where curve C passes through damaged tissue. If the points on curve C that are associated with damaged tissue are used for interpolation or projection of reconstructed intensity values, the reconstructed values will be tainted. Ignoring these values along the curve C allows the system to rely only on valid data for the reconstruction calculations.

Another alternative approach to calculating a reconstructed intensity Iᵣ for each point P uses the intensity at each point Pᵢ. Define rᵢ as the distance between point P and point Pᵢ as shown in FIG. 8, and the reconstructed intensity of Iᵣ can be calculated as

$${I}_{r} = f ( {I}_{1} , … {I}_{N} , {P}_{1} , … {P}_{N} ) = \frac{{\sum }_{i = 1}^{N} {r}_{i}^{α} {I}_{i}}{{\sum }_{i = 1}^{N} {r}_{i}^{α}} ,$$

for N selected points in sound tooth areas, and a predetermined exponent α, which is preferably 2.

In yet another embodiment of the present invention, several points Pᵢ are selected in sound tooth areas of the image, where the points do not necessarily form a closed loop, but are preferably dispersed around the tooth image and around the damaged tooth area. Then the intensity at each point P in the damaged area can be calculated using a two-dimensional spline, a Bézier surface, or the distance-based interpolation function discussed above in relation to FIG. 5.

In another alternative embodiment, reconstruction of the intensities in damaged areas is achieved using additional intersection lines through the given point P with slope m′+(n·Δθ) for a predetermined angle Δθ and n∈{−3, −2, −1, 0, 1, 2, 3}. More or fewer multiples are used in various embodiments. As discussed above in relation to FIGS. 6 and 7, linear interpolation along each of these lines is performed to find a reconstructed intensity, then those values are combined to arrive at the reconstructed intensity Iᵣ to be used in further analysis.

Each of the individual images used in the analyses described herein may be expressed as grayscale images or in terms of RGB triples or YUV triples. In the case of component expressions, the interpolation calculations described above are preferably applied to each component of each pixel independently, though those skilled in the art will appreciate that variations on this approach and cross-over between components may be considered in reconstruction. Further, the images may be captured using any suitable technique known to those skilled in the art, such as those techniques discussed in the Software Repositioning patent.

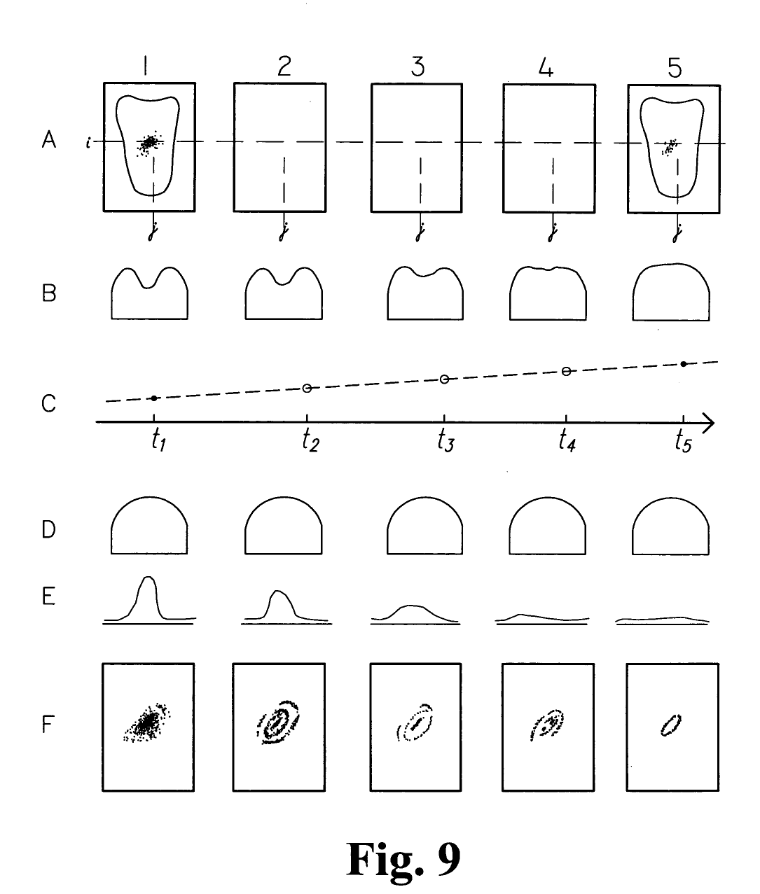

An important aspect of treatment is patient communication. One aspect of the present invention that supports such communication relates to the creation of animated “movies” using individual images captured with fluorescent techniques, where frames are added between those fixed images to smoothly change from each individual image to the next. One method for providing such animations according to the present invention is illustrated in FIG. 9. Row A in this illustration shows two actual images (in columns 1 and 5) with space left (in columns 2-4) for intervening cells in the animation. Row B of FIG. 9 shows the intensity values of each image from row A along line i. (Again, the present analysis may be applied to individual components of RGB or YUV component images.)

Row C of FIG. 9 shows intensity values from each image in the animation time sequence at pixel [i, j], which lies on line i. The points shown for times t₁ and t₅ are from images, while the points shown for times t₂-t₄ are interpolated based on times t₂-t₄ relative to t₁ and t₅, and the actual values at times t₁ and t₅.

Row D of FIG. 9 illustrates a graph of the reconstructed intensity values Iᵣ along line i for each image in the sequence. It may be noted that while the intensity graphs for each image are similar, they are not identical. These variations might be due, for example, to differences in the specific imaging parameters and positions used to capture the actual images. The reconstructed intensity values in row D are calculated independently for each image as discussed above.

The graphs shown in row B are then normalized by dividing each data value into the corresponding data value in the reconstructed data in row D, thus yielding the normalized data shown in row E. The normalized values shown in row E are obtained for each pixel in each image, and are combined to yield the images (frames) in row F. The series of images thus obtained yields an animated movie that functions like a weather map to illustrate the change in condition of the tooth, for better or worse. The illustrated sequences of images shows, for example, the remineralization of the white spot seen in the image at row A, column 1.

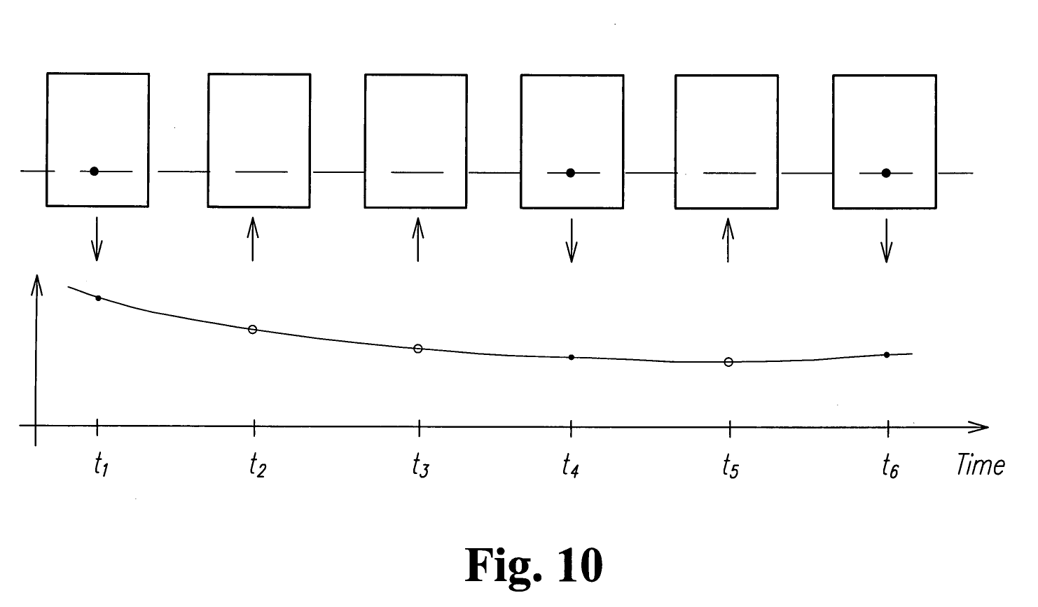

In various alternative embodiments, the calculation of intensity, luminance, or individual pixel component color values in cells not corresponding to actual captured images is performed using other curve-fitting techniques. For example, in some embodiments a spline is fitted to the intensity values of corresponding pixels in at least three images as shown in FIG. 10. In that illustration, the frames at times t₁, t₄, and t₆ are actual images, while images for times t₂, t₃, and t₅ are being synthesized. The fitted spline is used to select intensity values for points in the synthesized frames based on the real data captured in the images. In other alternative embodiments, linear interpolation is applied, a Bézier curve is fitted to the given data, or other curve-fitting techniques are applied as would occur to those skilled in the art based on the present disclosure. Whatever curve-fitting technique is used, the point on the curve corresponding to the time value for each frame is used to fill the pixel in that frame.

In various alternative embodiments of the “weather map” technique, the normalized white spot graphic or illustration (as shown in FIG. 9, row F) is shown alone. In other embodiments it is superimposed on the original images, while in still others it is displayed over the interpolated images as well. In some of these embodiments, the intensities shown in row E are displayed in grayscale, while in others they are shown in color that varies based on the magnitude of the normalized intensity of each pixel.

It is noted that the methods described and suggested herein are preferably implemented by a processor executing programming instructions stored in a computer-readable medium, as illustrated in FIG. 3. In various embodiments, function ƒ(i) depends on one or more “optical components” of the pixel, which might include red, green, blue, chrominance, luminance, bandwidth, and/or other component as would occur to one of skill in the art of digital graphic processing.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. Furthermore, all patents, publications, prior and simultaneous applications, and other documents cited herein are hereby incorporated by reference in their entirety as if each had been individually incorporated by reference and fully set forth.

What is claimed is:

1. A method of image analysis, comprising:
capturing a digital image of tooth tissue; and
for each of a plurality of pixels in the digital image:
determining a first component value of the pixel's color and a second component value of the pixel's color; and
calculating a first function value for the pixel based on the first component value and the second component value.

2. The method of claim 1, wherein the first component value is a red color component of the pixel.

3. The method of claim 2, wherein:
the second component value is a green color component of the pixel; and
the first function is a ratio of the red color component to the green color component.

4. The method of claim 1, further comprising creating a second image, wherein the creating includes using an alternate color for at least one pixel, and the alternate color is selected based on the first function value for the at least one pixel.

5. The method of claim 4,
wherein each of the plurality of pixels has an original color, and
further comprising displaying the digital image, substituting the selected alternate color in place of the original color for the plurality of pixels in the digital image.

6. The method of claim 4,
wherein each of the plurality of pixels has an original color, and
further comprising storing the digital image, substituting the selected alternate color in place of the original color for the plurality of pixels in the digital image.

7. The method of claim 1,
wherein the plurality of pixels includes all pixels in the image; and
further comprising displaying a subset of the plurality of pixels in an alternative color.

8. A method of quantifying mineral loss due to a lesion on a tooth, comprising:
capturing a digital image of the fluorescence of the tooth, the image comprising actual intensity values for a region of pixels;
selecting a plurality of points defining a closed contour around a first plurality of pixels;
calculating a reconstructed intensity value for each pixel in the first plurality of pixels; and
calculating the sum of the differences between
the reconstructed intensity values for each of a second plurality of pixels and
the actual intensity values for each of the second plurality of pixels.

9. The method of claim 8, wherein the first plurality of pixels is the same as the second plurality of pixels.

10. The method of claim 8, wherein the second plurality of pixels consists of those of the first plurality of pixels for which the actual intensity values are smaller than the reconstructed intensity values minus a predetermined threshold.

11. The method of claim 8, wherein the second plurality of pixels consists of those of the first plurality of pixels for which the actual intensity values are smaller than the reconstructed intensity values by a predetermined multiplicative factor.

12. The method of claim 8, wherein the actual intensity value for each pixel in the first plurality of pixels is a function of a single optical component of the pixel.

13. The method of claim 8, wherein the reconstructed intensity value for each pixel in the first plurality of pixels is calculated using linear interpolation.

14. The method of claim 13, wherein the linear interpolation for each given pixel is based on intensity values of one or more points on the contour.

15. The method of claim 14 wherein the one or more points on the contour lie on or adjacent to a line through the given pixel.

16. The method of claim 15
further comprising performing a linear regression analysis of the region surrounded by the contour to determine the slope m of a regression line; and
wherein the line through the given pixel is selected to have a slope of about −1/m.

17. The method of claim 14
further comprising performing a linear regression analysis of the region surrounded by the contour to determine the slope m of a regression line; and
wherein the one or more points on the contour lie on or adjacent to a set of lines lⱼ through the given pixel, and
wherein the slope of each line Iⱼ is selected to be (−1/m+nθ) for a predetermined slope differential θ and set of multipliers n.

18. The method of claim 8, wherein the reconstructed intensity value for each pixel is calculated as a function of intensity values of two or more points on the contour.

19. The method of claim 18, further comprising:
identifying one or more points to be ignored on the contour; and
excluding the one or more points to be ignored during the calculation of reconstructed intensity values.

20. The method of claim 18, wherein
the function is a function of
N selected points P₁, P₂, . . . P_{N} in the image that represent sound tooth tissue, where N>1,
rᵢ, the distance in the image between the pixel and a selected point Pᵢ in a sound tooth area,
Iᵢ, the intensity of point Pᵢ, and
a predetermined exponent α,
and is calculated as
$${I}_{r} = \frac{{\sum }_{i = 1}^{N} {r}_{i}^{α} {I}_{i}}{{\sum }_{i = 1}^{N} {r}_{i}^{α}} .$$

21. The method of claim 20, wherein α=2.

22. A system, comprising a processor and a memory, the memory being encoded with programming instructions executable by the processor to:
retrieve a first image of light that is the product of autofluorescence of a tooth having a white spot lesion, wherein the first image comprises pixels each having an original intensity;
determine a first plurality of points in the first image that define a contour substantially surrounding the lesion; and
calculate a reconstructed intensity for each pixel in the second image that lies within the contour; and
calculate a first result quantity based on two or more of the reconstructed intensities and two or more of the original intensities of pixels in the first image.

23. The system of claim 22, wherein the programming instructions are further executable by the processor to:
retrieve a second image of light that is the product of autofluorescence of the tooth, wherein
the second image comprises pixels each having an original intensity, and
the second image is captured at a different time than that at which the first image is captured;
determine a second plurality of points in the second image that define a contour substantially surrounding the lesion; and
calculate a reconstructed intensity for each pixel in the second image that lies within the contour; and
calculate a second result quantity based on two or more of the reconstructed intensities and two or more of the original intensities of pixels in the second image.
